(19) United States
(12) Patent Application Publication
(10) Pub. No.: US 2010/0273696 A1
(43) Pub. Date: Oct. 28, 2010

(54) Composition and method for the prevention and removal of unwanted paint on a surface

(76) Inventor: Herbert Hopfstock, Oxnard, CA (US)

Correspondence Address: SANDRA LEE LIPKIN A LAW CORPORATION, P.O.Box 3518, VENTURA, CA, 93006, US

(21) Appl. No.: 12/386,885

(22) Filed: Apr. 23, 2009

(51) Int. Cl. C11D 1/83; C11D 1/02; C09D 5/00

(52) U.S. Cl. 510/201; 510/413; 106/2

(57) ABSTRACT

An environmentally safe formulation to prepare an effective and permanent protection layer on almost all surfaces. The formulation consists of a combination of different silicon organic compounds, namely [a] end standing mono-, di- or tris-amino-alkyl-alkoxysilanes and [b] mono-, di-, or tris-alkyl-amino-alkylsilanes, in a long-chained isoparaffinic solution. The silicon organic compounds starts to polymerize in the presence of oxygen (air) and/or water (humidity), and builds up a net structure that water molecules can penetrate through the cured protective layer. Depending on the types of the silicon organic compounds, the pore width of the net structure can be verified. It is also possible to remove this protection layer, by using a special water based mixture of hydrofluoric acid and an inert surfactant.

### BACKGROUND OF THE INVENTION

1. Field of the Invention

This invention relates to compositions for the prevention and removal of unwanted paint and other inks and chemical materials that may be covering all kinds of surfaces, such as graffiti, rust, yellowing, and deterioration by the weather, and more particularly towards environmentally safe surface protection compositions and method of using same utilizing silicon organic compounds in an isoparaffinic organic solution

2. Description of the Prior Art

Graffiti on stone, such as monuments, facades, walls, bridges, traffic signs, cars, etc. look unsightly. The rusting of metals, (containers, tools, ships, etc.), the yellowing of paint, the deterioration of concrete by weather pollutants, and the weathering of wood can harm these surfaces, leading to a conspicuous loss of value, and ultimately to destruction of the surface or item.

In the case of graffiti, many stone, concrete, or block walls have a rough, relief finish. Graffiti, administered with spray paint, is propelled into the relief of the wall, and it is very difficult to remove except by sand blasting. Most of the time, however, the graffiti is not removed. Rather, the graffiti is covered with a patch of paint. Usually, the patches of paint do not color match the original paint or natural surface coloring surrounding the adjacent patch, thereby creating an unattractive pattern of different colored areas on a wall surface.

There is a need to provide a protective coating that can be easily applied with a paint brush, roller, or an airless sprayer on various types of surfaces, that stops paint penetration, and features the easy removal of paint by light scrubbing or power wash, depending on the kind of paint. Additionally, there is the need to provide a composition that can remove graffiti after it is applied.

### SUMMARY OF THE INVENTION

The invention comprises a system for the prevention and removal of graffiti comprising a composition for protecting surfaces against graffiti on stone, such as monuments, facades, walls, bridges, traffic signs and cars, as well as the rusting of metals, (containers, tools, ships, etc.), the yellowing of paint, and deterioration of concrete by weather pollutants and the weathering of wood. The formulation consists of a combination of different silicon organic compounds in a long-chained isoparaffic solution. The silicon organic compounds start to polymerize in the presence of oxygen (air) and/or water (humidity), and builds up a net structure that water molecules can penetrate through the cured protective layer. Depending on the types of silicon organic compounds, the pore width of the net structure can be verified. The result is an environmentally safe formulation that can prepare an effective and permanent protection layer on almost all surfaces, characterized by wide-range thermal stability, extreme water repellence, and physiological inertness.

This mixture consists of silicon organic compounds in a long-chained isoparaffinic solution containing end-standing mono-, di- or tris-amino-alkyl-alkoxysilanes and mono-, di- or tris-alkyl-amino-alkylsilanes.

Both of these kinds of silicon organic compounds are present in a range of 0.5 to 25.0% by weight in a long-chained isoparaffinic solution. In the studies of this invention, an isoparaffinic solution with a boiling point above 350 degrees Fahrenheit and an aromatic content lower than 0.01% by weight, was used. Also, other isoparaffinic solutions can be utilized.

### DETAILED DESCRIPTION OF A PREFERRED EMBODIMENT

This invention is a mixture of silicon-organic compounds in an isoparaffinic solution that builds up a three-dimensional net structured protective layer on almost all surfaces. The mixture contains
[a] End-standing mono-(x=1, y=3), di-(x=2, y=2) or tris-(x=3, y=1) amino-alkyl-alkoxysilanes (NH₂-Rₙ)ₓ—Si—(O—Rₘ)_{y}, in which the alkyl (Rₙ) of the amino-alkyl group and the alkyl (Rₘ) of the alkoxysilane group contains n,m=1-12 carbon atoms. The alkyl (Rₘ) of the alkoxysilane group can also be a cycloalkyl group, which contains m=5-16 carbon atoms. Alkylated cycloalkyl groups are also considered to be possible within the scope of this invention.
[b] Mono-(x=1, y=3), di-(x=2, y=2) or tris-(x=3, y=1) alkyl-amino-alkylsilanes (Rₙ)ₓ—Si—(NHRₘ)_{y}, in which the alkyl (Rₙ) of the alkyl-silane group and the alkyl (Rₘ) of the alkyl-amino group contains n,m=1-12 carbon atoms. The alkyl (Rₘ) of the alkyl-amino group can also be a cycloalkyl group, which contains m=5-16 carbon atoms. Alkylated cycloalkyl groups are also considered to be possible within the scope of this invention.

Both kinds of silicon organic compounds are present in a range of 0.5 to 25.0% by weight in a long-chained (ᵢₛₒC₁₀-ᵢₛₒC₂₀) isoparaffinic solution. An isoparaffinic solution with a boiling point above 350 degrees Fahrenheit and an aromatic content lower than 0.01% by weight is preferred, but other isoparaffinic solutions can also be utilized.

In addition to providing a means of preventing the application of graffiti to a surface, this above composition can also be used on the bottom of boats to prevent the attachment thereon of crustaceans and other sea life.

The system of graffiti prevention and removal disclosed herein also provides a composition for the safe and clean removal of graffiti already applied.

The paint remover composition of the invention has a high flash point ≧90° C., a high boiling point ≧150° C., a very low content of volatile organic compounds (VOC≦0.5 g/l) and a very low vapor pressure (Vap.p.^{20° C.}≦0.5 mm Hg). The pH is preferably neutral, but can be slightly acidic (pH 5.0-7.5). The composition is non-toxic, non-irritating, non-flammable and is biodegradable. The protective layer is not UV sensitive and has high temperature stability from −60 up to 660 degrees Fahrenheit. Because of its unique chemical composition, this protective layer is hydrophobic and reduces the flow resistance from ships in water. The solvation activity is believed to proceed as a result of a synergistic combination between poly alkoxylated anionic and/or nonionic surfactants portions and solvents of poly alkylen glycol alkyl ether in which both the surfactant and solvent have similar poly alkoxylated chains.

The solvation activity appears to proceed due to the matched polymeric surfactants that initialize an intermolecular reaction with the polymers in the paint. The overlapping electrostatic fields contribute to the separation of polymeric chains in the polymeric film formerly present in the paint and possibly to some depolymerization thereof to break cross-links and reduce chain length of the polymer chains as the paint dissolves.

The synergistic effect and solvation activity are not present when water is added to the composition. Water hydrates the surfactants forming sheaths, which isolate the surfactants from each other and from the polymer molecules in the film formerly found in the paint. Water can be used to deactivate the paint remover composition, such as after paint removal or to control an accidental spill.

The overlapping electrostatic fields are enhanced by the addition of nucleophilic-aprotic substances. The viscosity of the composition can be increased by adding a compatible thickener, preferably a hydroxyalkylated cellulose in the range of between 0.2 and 5.0% by weight. These thickeners have been found to not affect the synergistic solvation effect. When the pH is too low, a base such as an amine, suitably a di- or triethanolamine in the amount of 0.2 to 2.0% by weight, can be added to the composition.

The paint remover composition of the invention can be used to remove other materials from substrates such as ink, brushed paints, varnishes, resins, enamels, wax, glue, etc.

The synergism is demonstrated by a combination of 2 to 20 parts by weight of a poly alkoxylated surfactant (poly alkoxylated alkyl ethercarboxylic acid, poly alkoxylated alkyl ethercarboxylic ester, poly alkoxylated alkyl ethercarboxylate, poly alkoxylated fatty acid, poly alkylen glycol ester, poly alkoxylated alcohol etc.) of such as those of the formula R—[—O—CₙH₂ₙ—]ₘ—O—R⁽¹⁾ where R is a hydrocarbon group containing 1-30 carbon atoms such as alkyl, alkylaryl and fatty alkyl, preferably fatty alkyl containing 8-24 carbon atoms, where R⁽¹⁾ is a special group (see below), n is 2,3 or 4, m is at least 4 such that the anionic and/or nonionic surfactant is liquid, usually from 2 to 20, preferably from 2 to 10 and 10-90 parts by weight of a poly alkylene glycol alkyl ether of the formula: R⁽⁴⁾—[—O—CₙH₂ₙ—]ₘ—O—R⁽⁵⁾ where R⁽⁴⁾ and R⁽⁵⁾ are individually selected from the group consisting of H and alkyl of 1-10 carbon atoms, n is from 2 to 6, preferably from 2 to 4 and m is 2 to 10, preferably from 2 to 4.

poly alkoxylated surfactants R—[—O—CₙH₂ₙ—]ₘ—O—R⁽¹⁾
R = alkyl, alkylaryl, fatty alkyl R⁽¹⁾ = special group
n = 2 . . . 4 m = 4 . . . ∞

| Chemical name | Special formula |
|---|---|
| poly alkoxylated alkyl | R—[—O—CₙH₂ₙ—]ₘ—O—CH₂COOH |
| ethercarboxylic acid | R⁽¹⁾ = —CH₂COOH |
| poly alkoxylated alkyl | R—[—O—CₙH₂ₙ—]ₘ—O—CH₂COOR⁽²⁾ |
| ethercarboxylic ester | R⁽¹⁾ = —CH₂COOR⁽²⁾ |
| | R⁽²⁾ = alkyl, alkylaryl, fatty alkyl |
| poly alkoxylated alkyl | R—[—O—CₙH₂ₙ—]ₘ—O—CH₂COO⁻ M⁺ |
| ethercarboxylate | R⁽¹⁾ = —CH₂COO⁻M⁺, M⁺ = counterion |
| | (Na⁺, K⁺, NH₄⁺, Mg²⁺, TEA⁺, etc.) |
| poly alkoxylated fatty | R—[—O—CₙH₂ₙ—]ₘ—O—COR⁽³⁾ |
| acid, poly alkylen glycol | R⁽¹⁾ = —COR⁽³⁾ |
| ester | R⁽³⁾ = alkyl, alkylaryl, fatty alkyl or —H |
| poly alkoxylated alcohol | R—[—O—CₙH₂ₙ—]ₘ—OH |
| | R⁽¹⁾ = —H |

It is also possible, that the alkoxylated groups are mixed EO/PO block copolymers [—O—CₙH₂ₙ—]ₘ => [—O—CH₂CH₂—]ₓ[—O—CH(CH₃)CH₂—]_{y} x + y = m
poly alkylene glycol alkyl ether R⁽⁴⁾—[—O—CₙH₂ₙ—]ₘ—O—R⁽⁵⁾ R⁽⁴⁾; R⁽⁵⁾ = —H, alkyl n = 2 . . . 6 m = 2 . . . 10

The synergistic solvent activity decreases as the chain length of the alkylene ether group increases and is absent in ethers having a carbon length of 5 or more.

Other optional ingredients include poly alkoxylated alkyl acetates in an amount from 0-30% by weight, preferably 5-25% by weight, nucleophilic-aprotic solvents in an amount from 0-70% by weight, preferably 10-60% by weight, 0-2% by weight of a base such as a Group I or Group II metal hydroxide or a polyamine such as di- or triethanolamine and 0-5% by weight, preferably 1-3% by weight, of a thickening agent such as hydroxyalkyl cellulose in which the alkyl contains from 1-6 carbon atoms. The synergistic solvent activity decreases as the chain length of alkylene ether group increases and is absent in ethers having a carbon length of 5 or more.

The following formulations provide safe and effective paint removing compositions:

| | | |
|---|---|---|
| | Formula and | Range in % |
| Compound | chemical range | by weight |

MAJOR INGREDIENTS

| | | |
|---|---|---|
| poly alkoxylated | R—[—O—CₙH₂ₙ—]ₘ—O—R⁽¹⁾ | 2-20 |
| surfactants | R = alkyl, alkylaryl, fatty alkyl | |
| | R⁽¹⁾ = special group | |
| | n = 2 . . . 4 | |
| | m = 4 . . . ∞ | |
| poly alkylene glycol alkyl | R⁽⁴⁾—[—O—CₙH₂ₙ—]ₘ—O—R⁽⁵⁾ | 10-90 |
| ether | R⁽⁴⁾; R⁽⁵⁾ = —H, alkyl | |
| | n = 2 . . . 6 | |
| | m = 2 . . . 10 | |

OPTIONAL INGREDIENTS

| | | |
|---|---|---|
| poly alkylen glycol alkyl | R⁽⁶⁾—[—O—CₙH₂ₙ—]ₘ—O—CH₂COOR⁽⁷⁾ | 0-30 |
| acetate | R⁽⁶⁾; R⁽⁷⁾ = —H, alkyl | |
| | n = 2 . . . 6 | |
| | m = 2 . . . 10 | |
| nucleophilic-aprotic | ethylene or propylene carbonate, | 0-70 |
| substances | dimethylsulfoxide DMSO, | |
| | N-methyl-2-pyrrolidinone, | |
| | γ-butyrolactone etc. | |
| pH-buffer substances | KOH, | 0-2 |
| | di- or triethanolamine | |
| thickening agent | hydroxyalkyl cellulose | 0-5 |

Possible ingredients for use in the composition of the invention were tested for boiling point [Kp in ° C.], flash point [Fla.p. in ° C.], density [d_{20°C.} in g/ml], vapor pressure [Vap.p in mmHg], solubility in water and toxicity, results follow:

| | | | | | | |
|---|---|---|---|---|---|---|
| | Kp | Fla.p. | d(20° C.) | Vap.p. | Solubility | |
| Tested Compound | [° C.] | [° C.] | [g/ml] | [mmHg] | in H₂O | Toxicity |

R—[—O—CH₂CH₂—]ₙOCH₂COOH ethoxylated alkyl ethercarboxylic acids

| | | | | | | |
|---|---|---|---|---|---|---|
| R = —CH₂(CH₂)₇CH═CH(CH₂)₇CH₃; n = 9 | >200 | >100 | — | <0.01 | complete | none |
| oleyl ethercarboxylic acid (9 EO) | | | | | | |
| R = —CH₂(CH₂)₁₀CH₃; n = 10 | >200 | >100 | — | <0.01 | complete | none |
| lauryl ethercarboxylic acid (10 EO) | | | | | | |
| R = —CH₂(CH₂)₆CH₃; n = 8 | >200 | >100 | — | <0.01 | complete | none |
| octyl ethercarboxylic acid (8 EO) | | | | | | |
| R = —CH₂(CH₂)_{4/6}CH₃; n = 7 | >200 | >100 | — | <0.01 | complete | none |
| hexyl/octyl ethercarboxylic acid (7 EO) | | | | | | |
| R = —CH₂(CH₂)_{2/6}CH₃; n = 5 | >200 | >100 | — | <0.01 | complete | none |
| butyl/octyl ethercarboxylic acid (5 EO) | | | | | | |

R—[—O—CH₂CH₂—]ₙOCOR′ ethoxylated fatty acids, glycols and PEG esters

| | | | | | | |
|---|---|---|---|---|---|---|
| PEG-8 Oleate | >200 | >100 | — | <0.01 | complete | none |
| Castor Oil + 15 EO | >200 | >100 | — | <0.01 | complete | none |

R—[—O—(—CH₂)ₙ—]ₘ—O—R′ poly alkylen glycol alkyl ethers

| | | | | | | |
|---|---|---|---|---|---|---|
| R = —H; R′ = —CH₃; n = 2; m = 2 | 194 | 91 | 1.03 | 0.2 | complete | T |
| diethylene glycol monomethyl ether | | | | | | |
| R = R′ = —CH₃; n = 2; m = 2 | 162 | 53 | 0.95 | 5.3 | complete | T |
| diethylene glycol dimethyl ether | | | | | | |
| R = —H; R′ = —C₂H₅; n = 2; m = 2 | 202 | 94 | 0.99 | 0.1 | complete | none |
| diethylene glycol monoethyl ether | | | | | | |
| R = R′ = —C₂H₅; n = 2; m = 2 | 189 | 90 | 0.91 | 0.5 | complete | none |
| diethylene glycol diethyl ether | | | | | | |
| R = —H; R′ = —C₃H₇; n = 2; m = 2 | — | — | — | — | complete | none |
| diethylene glycol monopropyl ether | | | | | | |
| R = R′ = —C₃H₇; n = 2; m = 2 | — | — | — | — | complete | none |
| diethylene glycol dipropyl ether | | | | | | |
| R = R′ = —C₄H₉; n = 2; m = 2 | 228 | 105 | 0.95 | 0.2 | 10% | Xᵢ |
| diethylene glycol monobutyl ether | | | | | | |
| R = —H; R′ = —C₄H₉; n = 2; m = 2 | 256 | 118 | 0.88 | <0.01 | 0.3% | Xᵢ |
| diethylene glycol dibutyl ether | | | | | | |
| R = —H; R′ = —CH₃; n = 2; m = 3 | 250 | 133 | 1.04 | 0.1 | complete | none |
| triethylene glycol monomethyl ether | | | | | | |
| R = R′ = —CH₃; n = 2; m = 3 | 216 | 113 | 0.99 | 0.02 | complete | none |
| triethylene glycol dimethyl ether | | | | | | |
| R = —H; R′ = —CH₃; n = 2; m = 4 | — | — | — | — | complete | none |
| tetraethylene glycol monomethyl ether | | | | | | |
| R = R′ = —CH₃; n = 2; m = 4 | 275 | >130 | 1.01 | <0.01 | complete | none |
| tetraethylene glycol dimethyl ether | | | | | | |
| R = R′ = —CH₃; n = 2; m = 4 . . . 10 | >300 | >130 | 1.04 | <0.01 | complete | none |
| polyethylene glycol dimethyl ether | | | | | | |
| R = —H; R′ = —CH₃; n = 3; m = 2 | 189 | 80 | 0.95 | 0.5 | complete | none |
| dipropylene glycol monomethyl ether | | | | | | |
| R = R′ = —CH₃; n = 3; m = 2 | — | — | — | — | complete | none |
| dipropylene glycol dimethyl ether | | | | | | |
| R = —H; R′ = —C₂H₅; n = 3; m = 2 | — | — | — | — | complete | none |
| dipropylene glycol monoethyl ether | | | | | | |
| R = —H; R′ = —C₃H₇; n = 3; m = 2 | — | — | — | — | complete | none |
| dipropylene glycol monopropyl ether | | | | | | |
| R = —H; R′ = —C₄H₉; n = 3; m = 2 | — | — | — | — | — | none |
| dipropylene glycol monobutyl ether | | | | | | |
| R = —H; R′ = —CH₃; n = 3; m = 3 | 242 | 110 | 0.96 | 0.02 | complete | none |
| tripropylene glycol monomethyl ether | | | | | | |
| R = —H; R′ = —C₄H₉; n = 3; m = 3 | — | — | — | — | — | none |
| tripropylene glycol monobutyl ether | | | | | | |

nucleophilic-aprotic substances

| | | | | | | |
|---|---|---|---|---|---|---|
| ethylene carbonate | 248 | — | — | — | 21% | none |
| propylene carbonate | 241 | 135 | 1.21 | 0.03 | 24% | Xᵢ |
| γ-butyrolactone | 205 | 104 | 1.13 | 1.1 | complete | Xₙ |
| N-methyl-2-pyrrolidinone; NMP | 202 | 91 | 1.03 | 0.2 | complete | Xᵢ |
| dimethyl sulfoxide; DMSO | 189 | 95 | 1.10 | 0.5 | complete | none |
| 1,3-dimethyltetrahydro-2(1H)- | 247 | 120 | 1.06 | — | — | Xₙ |
| pyrimidinone | | | | | | |
| 1,3-dimethyl-2-imidazolidinone | 225 | 93 | 1.06 | — | — | none |

other compounds who are possible to add

| | | | | | | |
|---|---|---|---|---|---|---|
| [2-(2-butoxyethoxy)-ethyl]-acetate | 246 | 102 | 0.98 | <0.01 | 6.5% | none |
| diethyl acetonyl succinate | — | >110 | 1.07 | — | — | none |

RᵢOOC—[—CH₂—]ₙ—COORᵢ
Rᵢ = alkyl, n = 2 Dialkylsuccinate, n = 3 Dialkylglutarate, n = 4 Dialkyladipate

| | | | | | | |
|---|---|---|---|---|---|---|
| dimethyl succinate; Rᵢ = —CH₃; n = 2 | 196 | 90 | 1.12 | 0.2 | 7.5% | Xᵢ |
| dimethyl glutarate; Rᵢ = —CH₃; n = 3 | 212 | 107 | 1.09 | 0.07 | 4.3% | — |
| dimethyl adipate; Rᵢ = —CH₃; n = 4 | — | 102 | 1.06 | — | — | — |
| diethyl succinate; Rᵢ = —C₂H₅; n = 2 | 216 | 80 | 1.04 | — | — | — |
| diethyl glutarate; Rᵢ = —C₂H₅; n = 3 | 237 | — | 1.02 | — | — | — |
| diethyl adipate; Rᵢ = —C₂H₅; n = 4 | 242 | >100 | 1.01 | — | — | — |
| diisobutyl succinate; Rᵢ = —C₄H₇; n = 2 | — | — | — | — | — | — |
| diisobutyl glutarate; Rᵢ = —C₄H₇; n = 3 | — | — | — | — | — | — |
| diisobutyl adipate; Rᵢ = —C₄H₇; n = 4 | — | — | — | — | — | — |

F = flammable
T = toxic
Xᵢ= irritant
Xₙ = low irritant

The following compositions were prepared:

### EXAMPLE NO. 1

No. 1 (Classic)

| | |
|---|---|
| 5.0% | CH₃(CH₂)₇CH═CH(CH₂)₇CH₂—[—O—CH₂CH₂—]₉—OCH₂COOH |
| | oleyl ethercarboxylic acid (9 EO) |
| 19.2% | CH₃—[—O—CH₂CH₂—]₃—O—CH₃ |
| | triethylene glycol dimethyl ether (triglyme) |
| 25.0% | CH₃—[—O—CH₂CH₂—]₄—O—CH₃ |
| | tetraethylene glycol dimethyl ether (tetraglym) |
| 25.0% | CH₃—[—O—CH₂CH₂—]ₙ—O—CH₃ |
| | polyethylene glycol dimethyl ether (polyglyme) |
| 10.0% | H—[—O—CH₂CH₂CH₂—]₂—O—CH₃ dipropylene glycol monomethyl ether |
| 5.0% | 4-methyl-1,3-dioxolan-2-on (propylene carbonate) |
| 0.3% | triethanolamine (TEA) |
| 0.5% | hydroxypropyl cellulose |

The composition exhibited very strong performance and was found to remove spray paints including those based on polyurethane from surfaces. The composition can be used on stone, concrete, glass and metal surfaces. This composition will also remove paint from other surfaces and can dissolve plastic. Care should be taken to avoid applying this composition to surrounding paint and plastic parts.

### EXAMPLE NO. 2

No. 2 (Special)

| | |
|---|---|
| 5.0% | CH₃(CH₂)₇CH═CH(CH₂)₇CH₂—[—O—CH₂CH₂—]₉—OCH₂COOH |
| | oleyl ethercarboxylic acid (9 EO) |
| 81.7% | H—[—O—CH₂CH₂CH₂—]₂—O—CH₃ dipropylene glycol monomethyl ether |
| 12.5% | 4-methyl-1,3-dioxolan-2-on (propylene carbonate) |
| 0.3% | triethanolamine (TEA) |
| 0.5% | hydroxypropyl cellulose |

This composition, though high performance, is not as strong as the composition of Example No. 1. It will remove spray paints from most surfaces and will not affect an underlying film of paint. For example, graffiti can be removed from printed utility boxes, carpets, upholstery etc.

This product must remain on the graffiti or other stains less than 10 minutes, because plastics, the underlying paints and man-made fibers can be attacked if in contact with the composition for a longer period of time.

The compositions of Example No. 1 and No. 2 were varied by substituting poly alkylene glycol alkyl ether of increasing carbon content.

The solvation power of the paint remover composition is presented in the following table:

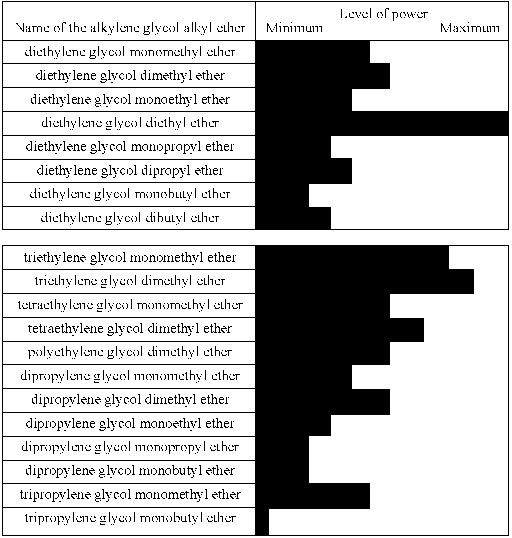

The compositions of Example No. 1 and No. 2 were varied by substituting various nucleophilic-aprotic solvents. Results follow:

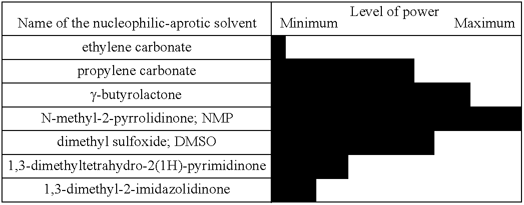

Paint removal with the composition of the invention is very simple. It will remove most spray paints (graffiti) but also ink, brushed or sprayed paints, varnishes, resins, enamels, wax, glue, etc. The paint remover product of the invention is environmentally sensitive and accomplishes the removal of paint or other substances in a simple, safe procedure.

The paint remover compositions consist of a finely balanced blend of anionic and/or nonionic surfactants with synergistic effects that operates with polymeric organic ether, ester and ketonic compounds. The products do not contain nitrate, sulphate, phosphate salts or other impurities such as halogenated solvents. They have neutral pH, are completely soluble in water or completely emulsifiable, having a high flash point (Fla.p. ≧90° C.), a high boiling point (Kp≧150° C.), a very low content of volatile organic compounds (VOC≦0.5 g/l) and a very low vapor pressure (Vap.p.^{20° C.}≦0.5 mm Hg). They are non-toxic, non-irritating, non-flammable and biodegradable.

The paint remover of the invention can be used on nearly all surfaces safely. The composition has a high efficiency. For each gallon, it is possible to remove paint on approximately 40 yd², depending on the kind of surfaces (textures from smooth to porous) and the constitution of the paint (age, thickness, quality). The products of the invention are far superior to all previous paint removal products.

The composition can simply be sprayed or brushed on surfaces that need paint removing. Leave it in place for 2 to 10 minutes, depending on the surfaces and constitutions of the paint (see above). After processing, it can be cleaned by rubbing off with a towel, sponge, brush, or preferably by means of a high pressure water sprayer (1,000 to 2,000 psi). It is important to wash the residue of the paint remover off with water to deactivate the solvent activity. Old or thick paint may require the process to be repeated two or three times. For thick paints it is helpful to use a wire brush before processing, to rough up the surface so that the paint removal products can penetrate faster. The composition should not be used at temperatures below 35° F. and outside in the rain. It is prudent to pre-test the surfaces for possible reactions with the products.

It is to be realized that only preferred embodiments of the invention have been described and that numerous substitutions, modifications and alterations are permissible without departing from the spirit and scope of the invention as defined in the following claims.

The illustrations and examples provided herein are for explanatory purposes only and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. A composition for cleaning surfaces comprising:
an anionic and/or nonionic poly alkoxylated surfactant; and a lower poly alkylene glycol alkyl ether having a repeating unit containing between 2 and 9 carbon atoms.

2. The composition as defined in claim 1 wherein said composition further comprises a polar aprotic solvent present in an amount from 1.0 to 70% by weight of the composition.

3. The composition as defined in claim 1 wherein said poly alkoxylated surfactant is selected from the group consisting of: a poly alkoxylated alkyl ether compound from the group consisting of: carboxylic acid, carboxylic ester, and carboxylate salt; a poly alkoxylated fatty acid; poly alkylene glycol ester; and poly alkoxylated alcohol.

4. The composition as defined in claim 3 wherein said surfactant contains a repeating alkoxy unit containing between 2 and 9 carbon atoms.

5. The composition as defined in claim 1 wherein said composition further comprises a thickener in an amount effective to form a gel-like composition.

6. The composition according to claim 5 wherein said thickener is a hydroxyl lower alkyl cellulose present in an amount between 0.2 and 5.0% by weight.

7. The composition as defined in claim 1 wherein said composition further comprises an additive effective to adjust the pH of the composition to between 5.0 and 7.5.

8. The composition as defined in claim 7 in which the pH adjusting additive is a Group I or Group II metal hydroxide or an amine selected from the group consisting of: diethanolamine and triethanolamine present in an amount between 0.2 and 2.0% by weight.

9. The composition as defined in claim 1 wherein said composition further comprises between 2 and 20 parts by weight of a poly alkoxylated surfactant; and between 10 and 90 parts by weight of a poly alkylene glycol alkyl ether.

10. The composition as defined in claim 7 wherein said poly alkoxylated surfactant is selected from compounds of the formula R—[—O—CₙH₂ₙ—]ₘ—O—R⁽¹⁾ where R is alkyl, alkylaryl and fatty alkyl containing 1-30 carbon atoms, n is 2, 3 or 4, m is at least 4 and R⁽¹⁾ is selected from the group consisting of: a poly alkoxylated alkyl ethercarboxylic acid, a poly alkoxylated alkyl ethercarboxylic ester, a poly alkoxylated alkyl ethercarboxylate, a poly alkoxylated fatty acid or poly alkylene glycol ester, and a poly alkoxylated alcohol where R⁽²⁾ is selected from the group consisting of: alkyl, alkylaryl, fatty alkyl of 1-3 carbon atoms, M⁺ is a counterion and R⁽³⁾ from the group consisting of: alkyl, alkylaryl, fatty alkyl and H.

11. A composition as defined in claim 10 in which said alkoxylated chain is formed of block copolymers.

12. A composition as defined in claim 11 wherein said copolymers are mixed ethylene oxide/propylene oxide block copolymers.

13. A composition as defined in claim 10 wherein M⁺ is a cation selected from the group consisting of: alkali and alkaline earth metal ions, ammonia and amines.

14. A composition as defined in claim 10 where said poly alkylene glycol alkyl ether is selected from compounds of the formula R⁽⁴⁾—[—O—CₙH₂ₙ—]ₘ—O—R⁽⁵⁾ where R⁽⁴⁾ and R⁽⁵⁾ are individually selected from the group consisting of: H and alkyl of between 1 and 10 carbon atoms, n is from 2-6 and m is from 2-10.

15. A composition as defined in claim 1 wherein said composition further includes between 1.0 and 30% by weight of a poly alkylene glycol alkyl acetate of the formula R⁽⁶⁾—[—O—CₙH₂ₙ—]ₘ—O—CH₂COOR⁽⁷⁾ where R⁽⁶⁾ and R⁽⁷⁾ are individually selected from the group consisting of: H and alkyl of between 1 and 30 carbon atoms, n is from 2-6 and m is from 2-10.

16. A composition as defined in claim 2 wherein said aprotic solvent is selected from the group consisting of: ethylene carbonate, propylene carbonate, dimethyl sufolxide, N-methyl-2-pyrolidinone and γ-butyrolactone.

17. A composition for removing paint from a substrate comprising in approximate parts by weight:
5 parts of oleyl ether carboxylic acid;
19 parts of triethylene glycol dimethyl ether;
25 parts of tetraethyelene glycol dimethyl ether;
25 parts of polyethyelene glycol dimethyl and ether; and
10 parts of dipropylene glycol monomethyl ether.

18. A composition as defined in claim 17 further including in approximate parts by weight:
5 parts of a polar aprotic solvent;
0.3 parts of a base; and
0.5 parts of a hydroxyalkylated cellulose thickener.

19. A composition for removing paint from a painted surface comprising in approximate parts by weight:
5 parts of oleyl ether carboxylic acid;
82 parts of dipropylene glycol monomethyl ether;
12 parts of a polar aprotic solvent;
0.3 parts of a base; and
0.5 parts of a thickener.

20. A composition as defined in claim 19 wherein said base is triethanolamine and said thickener is hydroxypropyl cellulose.

21. A method for removing discrete portions of a material from a surface comprising the steps of:
applying the composition of claim 1 to said portions for a time period sufficient to release said discrete portions from said surface and form a residue from the combination of said composition and said discrete portions; and
removing said residue from said surface.

22. A method as defined in claim 21 wherein said portions are paint and said residue is removed by applying water to said surface.

23. A composition for providing a protective coating to a surface comprising:
a first silicon organic compound;
a second silicon organic compound; and
an isoparaffinic solution.

24. The composition as defined in claim 23 wherein said first silicon organic compound and said second silicon organic compound is taken from the group consisting of:
end-standing mono-, di- or tris-amino-alkyl akloxysilanes; and
mono-, di- or tris-aklyl-amino-aklylsilanes.

25. The composition as defined in claim 23 wherein said first silicon organic compound and said second silicon organic compound is present in a range between 0.5 to 25.0% by weight.

26. The composition as defined in claim 23 wherein said isoparaffinic solution has a boiling point above 350 degrees Fahrenheit and an aromatic content lower than 0.01% by weight.
